(19) United States
(12) Patent Application Publication
(10) Pub. No.: US 2006/0088311 A1
(43) Pub. Date: Apr. 27, 2006

(54) IMAGE-CAPTURING APPARATUS WITH A LENS COVER

(76) Inventor: Hsuan-Chang Lu, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/163,635

(22) Filed: Oct. 25, 2005

(30) Foreign Application Priority Data
Oct. 27, 2004 (TW) 093132569

(51) Int. Cl. G03B 17/00

(52) U.S. Cl. 396/448

(57) ABSTRACT

An image-capturing apparatus includes a main body comprising a first hole, and a lens assembly installed inside the main body for projecting from the first hole of the main body in a rotatable manner. The lens assembly includes a gear installed on the outer surface of the lens assembly. The image-capturing apparatus further includes a lens cover installed on the main body in a slidable manner for covering the lens assembly, and a linking unit connected to the lens assembly and the lens cover. The linking unit includes a rack fixed on the lens cover for engaging with the gear of the lens assembly so as to drive the lens cover to slide on the main body when the lens assembly rotates.

### BACKGROUND OF THE INVENTION

1. Field of the Invention

The present invention relates to an image-capturing apparatus, and more particularly, to an image-capturing apparatus capable of opening a lens cover when a barrel rotates and projects from a main body simultaneously.

2. Description of the Prior Art

Digital cameras have become popular digital products and are positioned to eventually replace conventional film cameras due to low prices and compatibility with other electronic peripherals. As for digital cameras with an optical focus function, the lens is usually extendable and the lens assembly is installed inside a barrel for deciding the focus of the object. However conventional mechanisms of lens covers include the following types. A first type is that in which the lens cover is installed inside the lens and the lens cover is driven to open or close by a driven mechanism. Because the lens cover is installed inside the lens, the inner space of the lens is occupied resulting in the mechanical design becoming more complicated and resulting in an increase in the required measuring precision and assembly precision. A second type is that in which the lens cover is installed in front of the lens and users have to remove the lens cover manually for capturing images. For preventing an error of operating the lens without removing the lens cover, a switch sensor is installed in the digital camera for controlling the digital camera such that when sensing the presence of the lens cover, the digital camera is not capable of operating without the lens cover first being removed. However this presents an inconvenience to users for removing the lens cover manually and the switch sensor increases the cost of the digital camera. A third type is that in which a motor and a corresponding transmission mechanism are utilized for driving the lens cover, resulting in a cost increase for manufacturing the camera and the inner space of the digital camera being occupied.

### SUMMARY OF THE INVENTION

It is therefore a primary objective of the claimed invention to provide an image-capturing apparatus capable of opening a lens cover when a barrel rotates and projects from a main body simultaneously for solving the above-mentioned problem.

According to claimed invention, an image-capturing apparatus includes a main body comprising a first hole, and a lens assembly installed inside the main body for projecting from the first hole of the main body in a rotatable manner. The lens assembly includes a gear installed on the outer surface of the lens assembly. The image-capturing apparatus further includes a lens cover installed on the main body in a slidable manner for covering the lens assembly, and a linking unit connected to the lens assembly and the lens cover. The linking unit includes a rack fixed on the lens cover for engaging with the gear of the lens assembly so as to drive the lens cover to slide on the main body when the lens assembly rotates.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective drawing of an image-capturing apparatus according to the present invention.

FIG. 2 is an outer drawing of the image-capturing apparatus when a lens cover covers a lens completely.

FIG. 3 is an inner drawing of the image-capturing apparatus when the lens cover covers the lens completely.

FIG. 4 is an outer drawing of the image-capturing apparatus when the lens cover covers the lens partly.

FIG. 5 is an inner drawing of the image-capturing apparatus when the lens cover covers the lens partly.

FIG. 6 is an outer drawing of the image-capturing apparatus when the lens cover does not cover the lens completely

FIG. 7 is an inner drawing of the image-capturing apparatus when the lens cover does not cover the lens completely.

### DETAILED DESCRIPTION

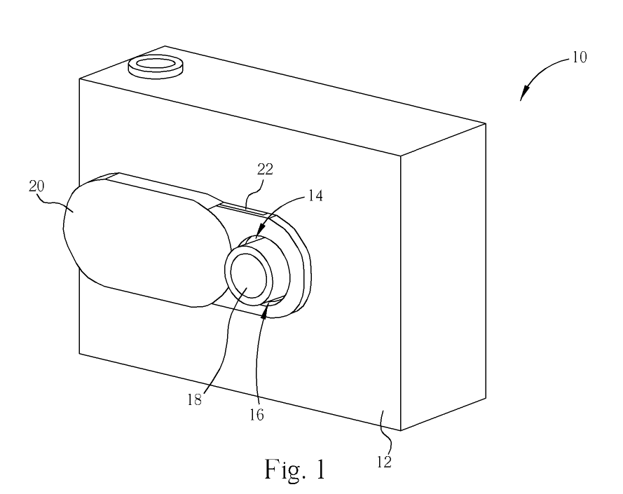

Please refer to FIG. 1. FIG. 1 is a perspective drawing of an image-capturing apparatus 10 according to the present invention. The image-capturing apparatus can be a film camera or a digital camera. The image-capturing apparatus 10 includes a main body 12 for covering inner components of the image-capturing apparatus 10. A first hole 14 and a second hole 22 are positioned on the main body 12. The image-capturing apparatus 10 further includes a lens assembly 16 installed inside the first hole 14 of the main body 12 in a rotatable manner. The lens assembly 16 includes a lens 18 installed inside the lens assembly 16 in a movable manner perpendicular to the rotating direction of the lens assembly 16 for capturing images. The image-capturing apparatus 10 further includes a lens cover 20 installed on the main body 12 in a slidable manner for covering the lens 18. The lens is extendable inside the lens assembly 16, so the image-capturing apparatus 10 has an optical focus function.

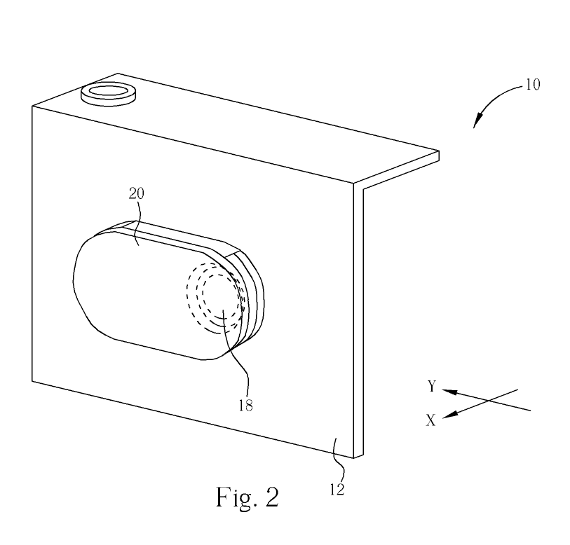

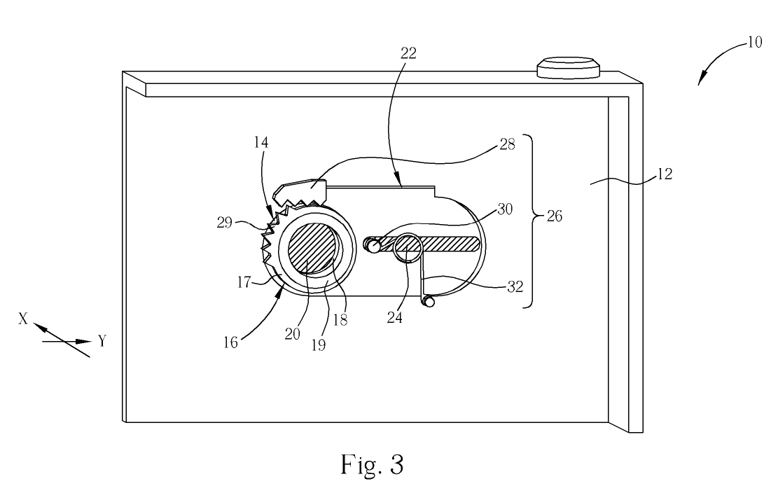

Please refer to FIG. 2 and FIG. 3. FIG. 2 is an outer drawing of the image-capturing apparatus 10 when the lens cover 20 covers the lens 18 completely, and FIG. 3 is an inner drawing of the image-capturing apparatus 10 when the lens cover 20 covers the lens 18 completely. A third hole 24 is positioned on the main body 12. The lens assembly 16 further includes a first barrel 17 installed inside the main body 12 in a rotatable manner, and a gear 29 is installed on the outer surface of the first barrel 17. The lens assembly 16 further includes a second barrel 19 connected to the first barrel 17 and projects from the first hole 14 of the main body 12 in a rotatable manner. The lens 18 is installed inside the second barrel 19. The image-capturing apparatus 10 further includes a linking unit 26 for driving the lens cover 20 to slide on the main body 12 when the lens assembly 16 rotates. The linking unit 26 includes a rack 28 installed inside the second hole 22 in a slidable manner and fixed on the lens cover 20 for engaging with the gear 29 so as to drive the lens cover 20 to slide on the main body 12 when the first barrel 17 rotates. The linking unit 26 further includes a sliding rod 30 installed inside the second hole 24 and fixed on the lens cover 20, and an elastic structure 32 connected to the main body 12 at one end and connected to the sliding rod 30 at the other end for providing an elastic force to drive the sliding rod 30. The sliding rod 30 slides a predetermined distance inside the third hole 24, so that the elastic force is generated. The sliding rod therefore slide from a first position to a second position after the sliding rod 30 slides the predetermined distance. The elastic structure 32 can be a spring. As shown is FIG. 2 and FIG. 3, when the lens cover 20 covers the lens 18 completely, the rack 28 is positioned at a side near to the lens assembly 16 inside the second hole 22 and engages the gear 29. The sliding rod 30 is at the first position near to the lens assembly 16 inside the third hole 24.

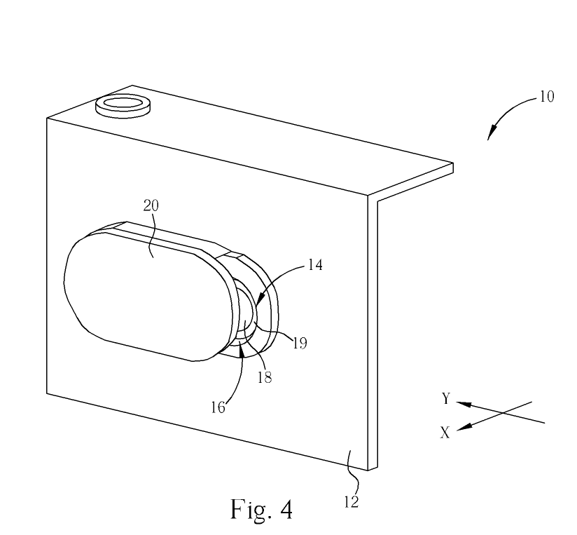

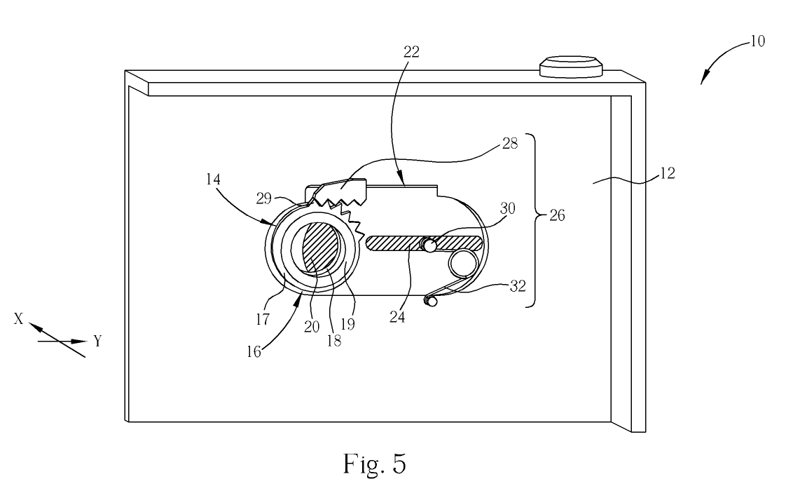

Please refer to FIG. 4 and FIG. 5. FIG. 4 is an outer drawing of the image-capturing apparatus 10 when the lens cover 20 covers the lens 18 partly, and FIG. 5 is an inner drawing of the image-capturing apparatus 10 when the lens cover 20 covers the lens 18 partly. When the first barrel 17 rotates clockwise inside the first hole 14 for driving the lens 18 inside the second barrel 19 to project out from the main body 12 in the X direction. The X direction is perpendicular to the rotating direction of the first barrel 17. Due to the engagement of the gear 29 and the rack 28, the first barrel 17 drives the rack 28 to slide in the Y direction away from the first barrel 17 inside the second hole 22. At the same time, the rack 28 drives the lens cover 20 to slide on the main body 12 in the Y direction and the sliding rod 30 slides in the Y direction away from the first barrel 17 inside the third hole 24 with the lens cover 20. Therefore the elastic structure 32 is driven by the sliding rod 30 to move a distance from the first position as shown in FIG. 3. The elastic coefficient of the elastic structure 32 can be selected for providing an elastic force to drive the sliding rod 30 to slide from the first position to a second position away from the first barrel 17 inside the third hole 24 after the sliding rod 30 slides in the predetermined distance from the first position inside the third hole 24, such as sliding to the middle of the third hole 24. In addition, when the first barrel 17 rotates clockwise inside the first hole 14 for driving the lens 18 inside the second barrel 19 to project from the main body 12 in the X direction perpendicular to the rotating direction of the first barrel 17, the lens cover 20 still covers the lens 18 partly. A gap between the lens cover 20 the second barrel 19 needs to be kept for preventing the lens cover 20 from interfering with the movement of the second barrel 19.

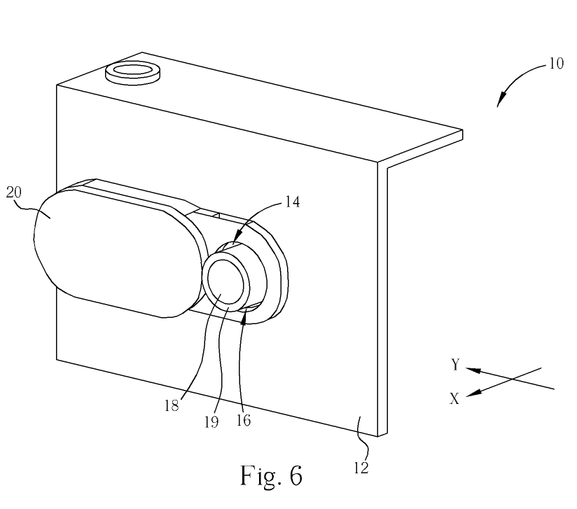

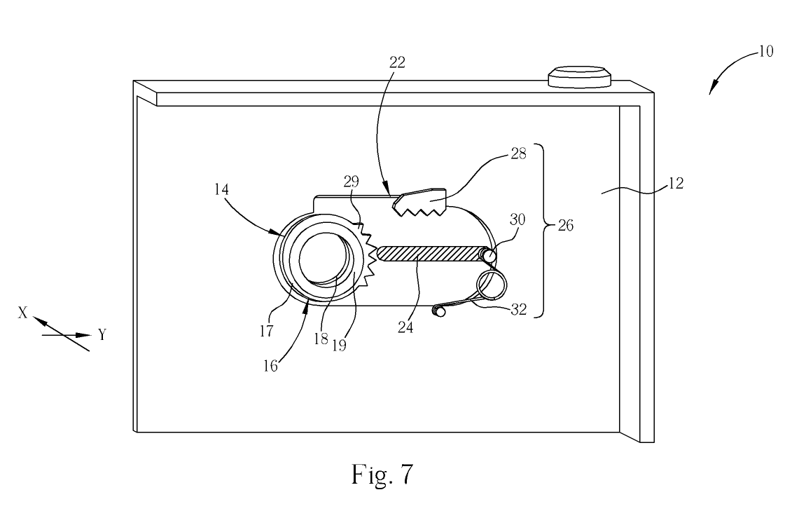

Please refer to FIG. 6 and FIG. 7. FIG. 6 is an outer drawing of the image-capturing apparatus 10 when the lens cover 20 uncover the lens 18 completely, and FIG. 7 is an inner drawing of the image-capturing apparatus 10 when the lens cover 20 does not cover the lens 18 at all. After the sliding rod 30 slides a predetermined distance from the first position as shown in FIG. 3 inside the third hole 24, the elastic structure 32 drives the sliding rod 30 to slide from the first position to the second position away from the first barrel 17 inside the third hole 24 as shown in FIG. 7. At the same time, the lens cover 20 is driven by the sliding rod 30 to slide in the Y direction on the main body 12. Finally the lens cover 20 is open and does not cover the lens 18, the second barrel 19 projects out from the main body 12 completely, and the rack 28 slides to the side away from the first barrel 17 inside the second hole 22 driven by the lens cover 20.

After capturing images with the image-capturing apparatus 10 according to the present invention and the second barrel 19 draws back inside the main body 12, users can manually move the lens cover 20 in the negative Y direction for covering the lens 18.

In contrast to the prior art, the image-capturing apparatus according to the present invention can open the lens cover and project the lens simultaneously. The present invention makes it convenient for users to open the lens cover, and can prevent the possibility of trying to operate the lens without removing the lens cover. In addition, there is no need to apply additional driving devices, such as a motor, a switch sensor, and so on, for driving the lens cover of the image-capturing apparatus according to the present invention, so the inner space of the image-capturing apparatus is not occupied and the cost can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image-capturing apparatus comprising:
a main body comprising a first hole;
a lens assembly installed inside the main body for projecting from the first hole of the main body in a rotatable manner, the lens assembly comprising a gear installed on the outer surface of the lens assembly;
a lens cover installed on the main body in a slidable manner for covering the lens assembly; and
a linking unit connected to the lens assembly and the lens cover, the linking unit comprising a rack fixed on the lens cover for engaging with the gear of the lens assembly so as to drive the lens cover to slide on the main body when the lens assembly rotates.

2. The image-capturing apparatus of claim 1 wherein the linking unit further comprises:
a sliding rod fixed on the lens cover; and
an elastic structure connected to the main body at one end and connected to the sliding rod at the other end for providing an elastic force to drive the cover lens.

3. The image-capturing apparatus of claim 2 wherein the main body further comprises a third hole and the sliding rod is slidable inside the third hole.

4. The image-capturing apparatus of claim 1 wherein the main body further comprises a second hole and the rack is slidable inside the second hole.

5. The image-capturing apparatus of claim 1 wherein the lens assembly further comprises:
a first barrel installed inside the main body in a rotatable manner, the gear being disposed on the first barrel;
a second barrel connected to the first barrel for projecting from the first hole of the main body in a rotatable manner; and
a lens installed inside the second barrel in a movable manner perpendicular to the rotating direction of the first barrel and the second barrel for capturing images.

6. The image-capturing apparatus of claim 1 wherein the elastic structure is a spring.
